(19) United States
(12) Patent Application Publication
(10) Pub. No.: US 2026/0360004 A1
(43) Pub. Date: Nov. 12, 2026

(54) SENSOR SYSTEM TO DETERMINE SEED ORIENTATION AND SEED PERFORMANCE DURING PLANTING OF AGRICULTURAL FIELDS

(71) Applicant: Precision Planting LLC, Tremont, IL (US)

(72) Inventor: Keith T. Strang, Zimmerman, MN (US)

(73) Assignee: Precision Planting LLC, Tremont, IL (US)

(21) Appl. No.: 19/135,581

(22) PCT Filed: Nov. 27, 2023
(86) PCT No.: PCT/IB2023/061921

§ 371 Date: Jun. 4, 2025

Related U.S. Application Data
(60) Provisional application No. 63/387,141, filed on Dec. 13, 2022.
(60) Provisional application No. 63/387,143, filed on Dec. 13, 2022.

(51) Int. Cl. G06T 7/73; A01C 7/10; G06T 7/90

(52) U.S. Cl. CPC G06T 7/73; A01C 7/105; G06T 7/90; G06T 2200/24; G06T 2207/10024; G06T 2207/30188

(57) ABSTRACT

A system having one or more seed sensors disposed at a first orientation with a seed passageway of a row unit, the one or more seed sensors each include a camera to capture images of seed passing through the seed passageway; and a processor communicatively coupled to the one or more seed sensors or integrated with the one or more seed sensors, wherein the processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

### CROSS REFERENCE TO RELATED APPLICATIONS

This application claims priority to U.S. Application Nos. 63/387141, filed 13 Dec. 2022, and 63/387143, filed 13 Dec. 2022, all of which are incorporated herein by reference in their entireties.

### TECHNICAL FIELD

Embodiments of the present disclosure relate to systems, implements, and methods for using a sensor system to determine seed orientation and seed performance within a seed passageway during planting within seed furrows or trenches of agricultural fields.

### BACKGROUND

Planters are used for planting seeds of crops (e.g., corn, soybeans) in a field. Seeds need to be planted with consistent spacing and with a high speed to decrease planting time. However, the seeds are delivered within a furrow or trench in a non-uniform manner and this can negatively affect growth conditions of the crops.

### BRIEF DESCRIPTION OF THE DRAWINGS

FIG. 1 shows an example of a system for performing agricultural operations (e.g., planting operations) of agricultural fields including operations of an implement having row units in accordance with one embodiment.

FIG. 2 illustrates an architecture of an implement 200 for planting operations in trenches of agricultural fields in accordance with one embodiment.

FIG. 3 illustrates an embodiment in which the row unit 300 is a planter row unit having seed orientation functionality during planting in accordance with one embodiment.

FIG. 4A illustrates a view of a sensor system 400 for precisely monitoring seed orientation within a seed passageway (e.g., seed tube, seed conveyor) during planting of agricultural plants (e.g., corn plants, soybean plants, etc.) in accordance with one embodiment.

FIG. 4B illustrates a block diagram of a sensor system in accordance with one embodiment.

FIGS. 5-7 illustrate different orientations of sensor arrays of a sensor system with respect to a seed passageway (e.g., seed tube, seed conveyor) in accordance with some embodiments.

FIG. 8 illustrates amplitude of reflectance signals of sensor array A and sensor array B in accordance with one embodiment.

FIG. 9 illustrates amplitude of reflectance signals of sensor array A and sensor array B in accordance with one embodiment.

FIG. 10 illustrates amplitude of reflectance signals of sensor array A and sensor array B in accordance with one embodiment.

FIG. 11A-11D illustrate how reflectance signals of sensor array A and sensor array B are utilized to determine double seed and seed orientation in accordance with one embodiment.

FIG. 12A illustrates a seed 1210 having a sideways orientation in a passageway 1202.

FIG. 12B illustrates a seed 1220 having a forward tip down orientation in a passageway 1202.

FIG. 12C illustrates a seed 1230-1 having a backward tip up orientation in a passageway 1202.

FIG. 13 illustrates a flow diagram of one embodiment for a computer-implemented method of using reflectance signals captured by a sensor system to monitor and determine seed orientation in a seed passageway of an implement in an agricultural field.

FIG. 14 illustrates a flow diagram of one embodiment for a computer-implemented method of using images captured by a vision based system to generate and display seed orientation data for different regions in geo-referenced locations in an agricultural field.

FIG. 15A shows an example of a block diagram of a self-propelled implement 140 (e.g., sprayer, spreader, irrigation implement, etc.) in accordance with one embodiment.

FIG. 15B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

FIG. 16 illustrates a flow diagram of an alternative embodiment for a computer-implemented method of using images captured by a vision based system to generate and display seed orientation data for different regions in geo-referenced locations in an agricultural field.

FIG. 17 illustrates a binarized image used for determining seed orientation data in accordance with the alternative embodiment of FIG. 16.

### BRIEF SUMMARY

In an aspect of the disclosure there is provided a system comprising a first sensor array disposed at a first orientation with a seed passageway of a row unit. The first sensor array includes a first plurality of sensors with each sensor to transmit light through the seed passageway and receive reflected light from seed to generate a reflectance signal. An optional second sensor array is disposed at a second orientation with the seed passageway of the row unit. The second sensor array includes a second plurality of sensors with each sensor to transmit light through the seed passageway and receive reflected light from seed to generate a reflectance signal. A processor is communicatively coupled to the first sensor array and the optional second sensor array, wherein the processor is configured to analyze reflectance signals from the first sensor array and the optional second sensor array to determine attributes including one or more of slope, amplitude, pulse width, offset between peaks, and sensor location of the reflectance signals, and to determine in passageway seed orientation based on the determined attributes of the reflectance signals from the sensors.

In one example of the system, wherein the processor is further configured to determine seed information including a shape of a seed edge, a seed tip location, double seeds, a velocity, and dimensions of seed based on the determined attributes of the reflectance signals.

In one example of the system, wherein the processor is further configured to determine whether a shape of a seed edge has a forward or backward orientation based on the slope of a reflectance signal.

In one example of the system, wherein the processor is further configured to determine a distance from a sensor to the seed in the seed passageway based on an amplitude of a reflectance signal.

In one example of the system, wherein the processor is further configured to determine seed orientation include a flyer, a tumbler, a rotator, and a sideway orientation based on amplitudes of reflectance signals from different sensors.

In one example of the system, wherein the processor is further configured to determine a seed tip location, forward or backward orientation, and whether a seed is angled based on an offset between peaks of reflectance signals.

In one example of the system, wherein the processor is further configured to determine double seeds or a sideways seed based on pulse widths of reflectance signals.

In one example of the system, wherein the processor is further configured to determine timing and perspective of the reflectance signals to infer velocity, length, and orientation of seed passing through light planes of the sensors of the sensor arrays.

In one example of the system, wherein the first sensor array comprises an array of light-emitting diode sensors.

In an aspect of the disclosure there is provided an agricultural implement comprising a seed passageway to deliver seed to a seed furrow in an agricultural field, at least one sensor disposed at a first orientation with the seed passageway. Each sensor to transmit light across the seed passageway and receive reflected light from seed to generate a reflectance signal. Optionally at least one sensor is disposed at a second orientation with the seed passageway of the row unit. Each sensor to transmit light across the seed passageway and receive reflected light from seed to generate a reflectance signal. A processor is communicatively coupled to the at least one sensor disposed at the first orientation and the optional at least one sensor disposed at the second orientation, wherein the processor is configured to analyze reflectance signals from the at least one sensor disposed at the first orientation and the at least one sensor disposed at the second orientation to determine attributes including one or more of slope, amplitude, pulse width, offset between peaks, and sensor location of the reflectance signals, and to determine in passageway seed orientation based on the determined attributes of the reflectance signals from the sensors.

In one example of the agricultural implement, wherein the processor is further configured to determine seed information including a shape of a seed edge, a seed tip location, double seeds, a velocity, and dimensions of seed based on the determined attributes of the reflectance signals.

In one example of the agricultural implement, wherein the processor is further configured to determine whether a shape of a seed edge has a forward or backward orientation based on the slope of a reflectance signal.

In one example of the agricultural implement, wherein the processor is further configured to determine a distance from a sensor to the seed in the seed passageway based on an amplitude of a reflectance signal.

In one example of the agricultural implement, wherein the processor is further configured to determine a seed tip location, forward or backward orientation, and whether a seed is angled based on an offset between peaks of reflectance signals.

In one example of the agricultural implement, wherein the processor is further configured to determine double seeds or a sideways seed based on pulse widths of reflectance signals.

In one example of the agricultural implement, wherein the processor is further configured to determine timing and perspective of the reflectance signals to infer velocity, length, and orientation of seed passing through light planes of the sensors of the sensor arrays.

In one example of the agricultural implement, wherein the seed passageway comprises a seed tube or seed conveyor.

In another aspect of the disclosure there is provided a computer-implemented method, comprising receiving input including seed type for an application pass of an agricultural implement and beginning the application pass in an agricultural field, transmitting, with one or more sensors(e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) disposed on a seed passageway of the agricultural implement, light into the seed passageway, receiving, with the one or more sensors, reflectance signals from the light being reflected by the seed while the implement travels through an agricultural field, analyzing reflectance signals from the one or more sensors to determine attributes including one or more of slope, amplitude, pulse width, offset between peaks, and sensor location of the reflectance signals and determining in passageway seed orientation based on the determined attributes of the reflectance signals from the sensors.

In one example of the computer-implemented method, further comprises determining seed information including a shape of a seed edge, a seed tip location, double seeds, a velocity, and dimensions of seed based on the determined attributes of the reflectance signals.

In one example of the computer-implemented method, further comprises determining whether a shape of a seed edge has a forward or backward orientation based on the slope of a reflectance signal.

In another aspect of the disclosure there is provided a system comprising one or more seed sensors disposed at a first orientation with a seed passageway of a row unit and optionally one or more seed sensors disposed at a second orientation with the seed passageway. Each seed sensor includes a camera to capture images of seed passing through the seed passageway and a processor communicatively coupled to the seed sensor. The processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

In one example of the system, wherein the processor is further configured to determine a center of gravity for the seed and a major axis to minor axis ratio vector.

In one example of the system, wherein the processor is further configured to determine a seed orientation performance metric based on the determined seed orientation information.

In one example of the system, further comprising a display device to display the seed orientation information and the seed orientation performance metric based on one or more images of the in-passageway seed.

In another aspect of the disclosure there is provided an agricultural implement comprising a seed passageway to deliver seed to a seed furrow in an agricultural field, one or more seed sensors disposed at a first orientation with the seed passageway and optionally one or more seed sensors disposed at a second orientation with the seed passageway. Each seed sensor includes a camera to capture images of seed passing through the seed passageway and a processor communicatively coupled to the seed sensor. The processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of the one or more first color areas, and determine seed orientation information including seed orientation for the seed.

In one example of the agricultural implement, wherein the processor is further configured to determine a center of gravity for the seed and a major axis to minor axis ratio vector.

In one example of the agricultural implement, wherein the processor is further configured to determine a seed orientation performance metric based on the determined seed orientation information.

In one example of the agricultural implement, wherein the one or more seed sensors are disposed near an end of the seed passageway.

In one example of the agricultural implement, wherein the seed passageway comprises a seed tube or seed conveyor.

In one example of the agricultural implement, further comprising a display device to display the seed orientation information and the seed orientation performance metric based on one or more images of the in-passageway seed.

In another aspect of the disclosure there is provided a computer-implemented method, comprising receiving input including seed type for an application pass of an agricultural implement and beginning the application pass in an agricultural field, capturing, with one or more seed sensors disposed at a first orientation with a seed passageway and optionally one or more sensors disposed at a second orientation with the seed passageway, images of seed passing through the seed passageway, binarizing pixels of the captured images into a first color of pixels for seed or a second color of pixels for background regions, grouping first color pixels into one or more first color areas, analyzing one or more first color areas with a software program to fit an ellipse with a major axis and a minor axis to a shape of the one or more first color areas, and determining seed orientation information including seed orientation for the ellipse, which represents a seed.

In one example of the computer-implemented method, further comprising determining a center of gravity for the seed and a major axis to minor axis ratio vector.

In one example of the computer-implemented method, further comprising determining a seed orientation performance metric based on the determined seed orientation information.

In one example of the computer-implemented method, wherein the one or more seed sensors are disposed near an end of the seed passageway.

In one example of the computer-implemented method, wherein the seed passageway comprises a seed tube or seed conveyor.

In one example of the computer-implemented method, further comprising displaying, with a display device, the seed orientation information and the seed orientation performance metric based on one or more images of the in-passageway seed.

In another aspect of the disclosure there is provided a computer-implemented method, comprising: capturing, with one or more seed sensors disposed at a first orientation with a seed passageway, images of seed passing through a seed passageway of an agricultural implement, binarizing pixels of the captured images into a first color of pixels for seed or a second color of pixels for background regions, grouping first color pixels into one or more first color areas, determining a major axis for a first color area and a length of the major axis, determining a midpoint of the major axis for seed in order to approximate a center of pressure acting on the seed, determining a geometric centroid of the seed from the binarized image, and determining a vector from the centroid to the center of pressure.

In one example of the computer-implemented method, wherein the vector from the centroid to the center of pressure indicates a direction of a tip of the seed while in the seed passageway.

In one example of the computer-implemented method, wherein the one or more seed sensors are disposed near an end of the seed passageway.

### DETAILED DESCRIPTION

All references cited herein are incorporated herein in their entireties. If there is a conflict between a definition herein and in an incorporated reference, the definition herein shall control.

In order to optimize field production, the delivery of seed into a seed furrow during planting has changed. The standard method of seed delivery is a gravity drop system whereby a seed tube has an inlet positioned below the seed metering system. A singulated seed then drops from the metering system, down the seed tube and into a trench (furrow) prepared by opener blades disposed forward of the seed tube. This method can raise issues with seed placement, seed spacing, and relative velocity of the seed as the seed hits the ground.

Seed sensors can be disposed on a seed tube to monitor seed during planting. However, these seed sensors are limited to a 1 kHz read and may not detect corn seed traveling faster than 20 mph (350 inches/second) or smaller seed due to pulses being too short. These seed sensors have a small detection area and miss some seed passing through the seed tube. The seed sensors can not provide any performance data for seed orientation.

Uneven crop emergence limits overall yield potential. An optimized planting orientation for corn seed is to be planted tip down with the germ facing an adjacent row. Millions of acres of corn are planted and are not allowed to reach their full potential due to a now preventable problem. Uniform plant emergence is important for high-yield corn environments. Multiple studies show that planting corn tip down and germ facing adjacent row will dramatically improve your emergence window, leaf orientation, and will increase yield.

In one embodiment of the present disclosure, a seed sensor with multiple sensor arrays is able to detect seed orientation performance including small, high velocity seed even at velocities greater than 350 inches/second. The seed sensor is able to detect seed traveling anywhere on a seed path (e.g., flyers not in contact with a wall at times), detect double seed, detect seed velocity, and detect orientation performance (e.g., riding or sliding gently along a wall of the seed tube versus tumbling or rotating along a wall of the seed tube, riding path versus guide wall, tip forward versus tip backward, sideways orientation, rotating orientation, etc.).

The seed sensor is able to help a grower evaluate live performance of various seed sizes, seed lots, sorting options, batches for a field for orientation or other purposes, and coatings. The seed sensor can set expectations for as-planted orientation performance in the field and will indicate equipment failures (e.g., air source failure/disconnect, foreign object debris on a path surface causing tumblers, dirt/stocks clogging an exit, moisture or humidity causing hygroscopic seed coating to turn tacky). A coating on a seed itself and coating depositing on riding surface of a seed passageway will cause seed to tumble instead of slide.

In the following description, numerous details are set forth. It will be apparent, however, to one skilled in the art, that embodiments of the present disclosure may be practiced without these specific details. In some instances, well-known structures and devices are shown in block diagram form, rather than in detail, in order to avoid obscuring the present disclosure.

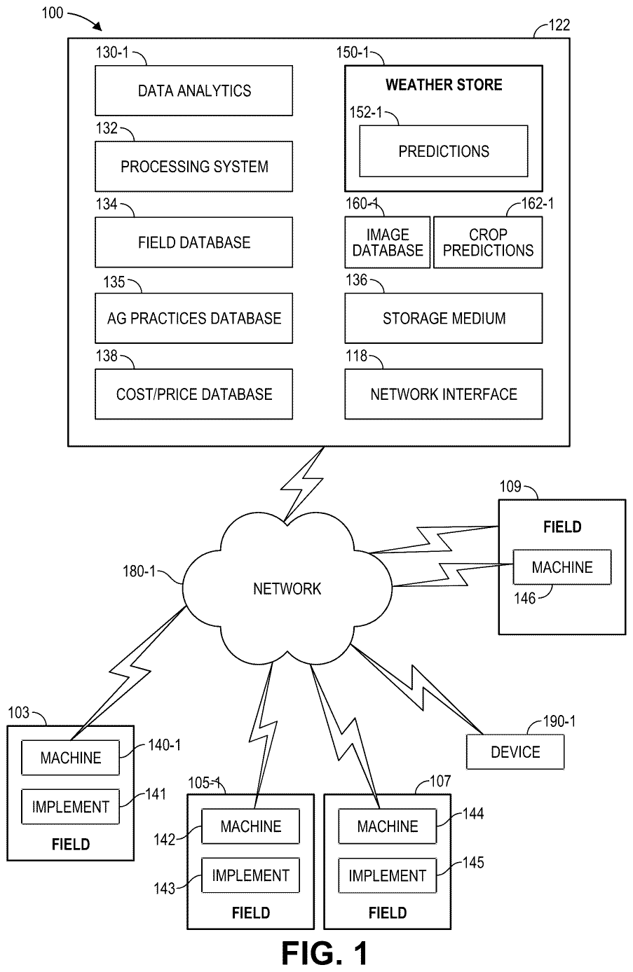

FIG. 1 shows an example of a system for performing agricultural operations (e.g., planting operations) of agricultural fields including operations of an implement having row units in accordance with one embodiment. For example, and in one embodiment, the system 100 may be implemented as a cloud based system with servers, data processing devices, computers, etc. Aspects, features, and functionality of the system 100 can be implemented in servers, planters, planter monitors, combines, laptops, tablets, computer terminals, client devices, user devices (e.g., device 190-1), handheld computers, personal digital assistants, cellular telephones, cameras, smart phones, mobile phones, computing devices, or a combination of any of these or other data processing devices.

In other embodiments, the system includes a network computer or an embedded processing device within another device (e.g., display device) or within a machine (e.g., planter, combine), or other types of data processing systems having fewer components or perhaps more components than that shown in FIG. 1. The system 100 (e.g., cloud based system) and agricultural operations can control and monitor planting operations for planting within a planting furrow or trench using an implement or machine. The system 100 includes machines 140-1, 142, 144, 146 and implements 141, 143, 145 coupled to a respective machine. The implements (or machines) can include row units for planting operations of crops within associated fields (e.g., fields 103, 105-1, 107, 109). The system 100 includes an agricultural analysis system 122 that includes a weather store 150-1 with current and historical weather data, weather predictions module 152-1 with weather predictions for different regions, and at least one processing system 132 for executing instructions for controlling and monitoring different operations (e.g., planting, fertilizing). The storage medium 136 may store instructions, software, software programs, etc. for execution by the processing system and for performing operations of the agricultural analysis system 122. In one example, storage medium 136 may contain a planting prescription (e.g., planting prescription that relates georeferenced positions in the field to planting parameters (e.g., soil type, downforce, speed, seed orientation, etc.). The implement 141 (or any of the implements) may include an implement 200 whose sensors and/or controllers may be specifically the elements that are in communication with the network 180 for sending control signals or receiving as-applied data.

An image database 160-1 stores captured images of crops at different growth stages and seed at different positions and orientation in a seed passageway during planting. A data analytics module 130-1 may perform analytics on agricultural data (e.g., images, weather, field, yield, etc.) to generate crop predictions 162-1 relating to agricultural operations.

A field information database 134 stores agricultural data (e.g., crop growth stage, soil types, soil characteristics, moisture holding capacity, etc.) for the fields that are being monitored by the system 100. An agricultural practices information database 135 stores farm practices information (e.g., as-applied planting information (e.g., seed orientation), as-applied spraying information, as-applied fertilization information, planting population, applied nutrients (e.g., nitrogen), yield levels, proprietary indices (e.g., ratio of seed population to a soil parameter), etc.) for the fields that are being monitored by the system 100. An implement can obtain seed orientation data and provide this data to the system 100. A cost/price database 138 stores input cost information (e.g., cost of seed, cost of nutrients (e.g., nitrogen)) and commodity price information (e.g., revenue from crop).

The system 100 shown in FIG. 1 may include a network interface 118 for communicating with other systems or devices such as drone devices, user devices, and machines (e.g., planters, combines) via a network 180-1 (e.g., Internet, wide area network, WiMax, satellite, cellular, IP network, etc.). The network interface include one or more types of transceivers for communicating via the network 180-1.

The processing system 132 may include one or more microprocessors, processors, a system on a chip (integrated circuit), or one or more microcontrollers. The processing system includes processing logic for executing software instructions of one or more programs. The system 100 includes the storage medium 136 for storing data and programs for execution by the processing system. The storage medium 136 can store, for example, software components such as a software application for controlling and monitoring planting operations or any other software application. The storage medium 136 can be any known form of a machine readable non-transitory storage medium, such as semiconductor memory (e.g., flash; SRAM; DRAM; etc.) or non-volatile memory, such as hard disks or solid-state drive.

While the storage medium (e.g., machine-accessible non-transitory medium) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present disclosure. The term “machine-accessible non-transitory medium” shall accordingly be taken to include, but not be limited to, solid-state memories, optical and magnetic media, and carrier wave signals.

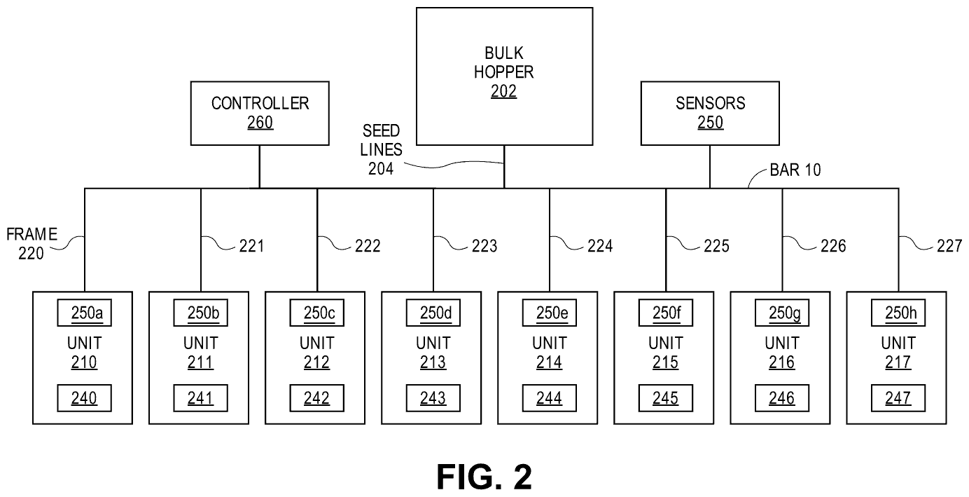

FIG. 2 illustrates an architecture of an implement 200 for planting operations in trenches of agricultural fields in accordance with one embodiment. The implement 200 (e.g., planter, cultivator, plough, etc.) includes at least one bulk hopper 202 with each bulk hopper containing a seed variety (e.g., a corn seed variety or a soybean variety). Each bulk hopper is preferably in fluid communication with an individual seed entrainer (not shown). Each seed entrainer is preferably mounted to a lower outlet of the associated bulk hopper 202. Each seed entrainer is preferably in fluid communication with a pneumatic pressure source and configured to convey air-entrained seeds through a plurality of seed lines 204 to the row units 210-217. A controller 260 (e.g., drive controller) is preferably configured to generate a drive command signal corresponding to a desired rate of seed disc rotation for seed meters of the row units. The drive controller 260 is preferably in data communication with a planter monitor of a machine. The implement also includes sensors 250 (e.g., speed sensors, seed sensors 250a-250h for detecting orientation and passage of seed such as sensor systems 400, 500, 600, 700, downforce sensors, actuator valves, speed sensors for the machine, seed force sensors for a planter, vacuum, lift, lower sensors for an implement, etc.) for controlling and monitoring operations of the implement. The sensors can be utilized on the implement 200 either row-by-row of row units as sensors 250a-250h or upstream of where the seed lines branches out to the row units as illustrated in FIG. 2. The sensors 250a-250h can be sensor systems 400, 500, 600, 700 with light arrays or each sensor can include a camera to capture images of seed passing through the seed passageway.

The row units are mechanically coupled to the frames 220-227 which are mechanically coupled to a bar 10. Each row unit can include sensors and components having a seed orientation mechanism (e.g., actuators, air pressure) for obtaining a proper seed orientation and/or positioning of seed during planting in a trench or furrow in an agricultural field. Each row unit may include a respective seed firmer 240-247 for positioning the seed within the trench at a certain depth and also includes a seed orientation functionality to change an orientation of the seed if desired. Each seed firmer can include a first seed vision system (e.g., machine vision, lidar (light detection and ranging)) to determine pre-orientation of the seed after placement in the trench with a seed tube, an actuator to change an orientation of the seed if necessary or desired at least partially based on the pre-orientation data, and a second seed vision system (e.g., machine vision, lidar (light detection and ranging)) to determine a post-orientation of the seed after the seed is positioned and oriented with the seed firmer to confirm that the seed has been orientated with a desired orientation or range of orientations. The row units can include any of the embodiments described herein in conjunction with FIGS. 2-4 and 7.

In an alternative embodiment, a seed orientation mechanism (e.g., actuators, air pressure) is located in a separate seed orientation component that is separate from the seed firmer. The first and second vision systems may also be integrated with the seed orientation component.

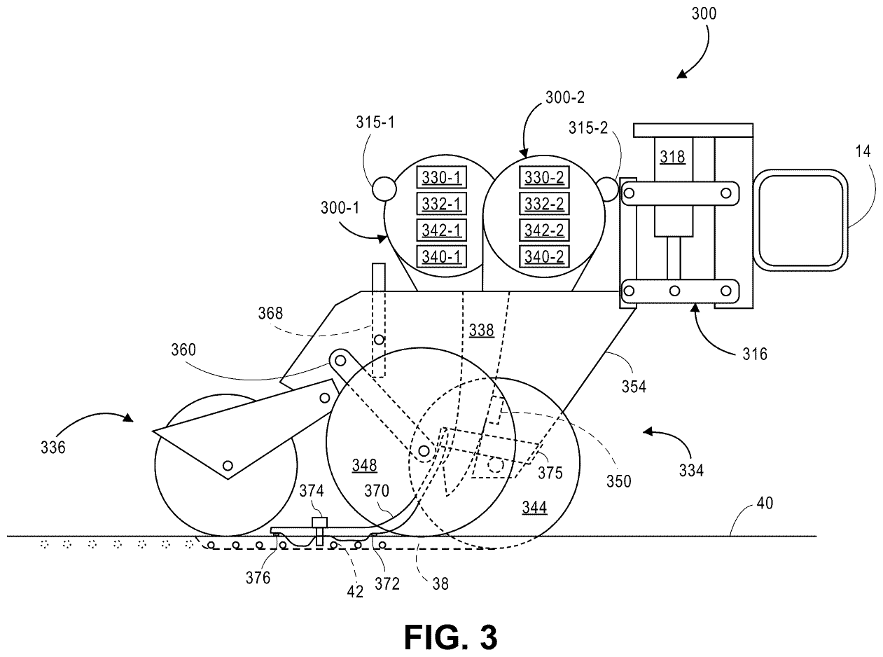

FIG. 3 illustrates an embodiment in which the row unit 300 is a planter row unit having seed orientation functionality during planting in accordance with one embodiment. The row unit 300 is preferably pivotally connected to the toolbar 14 (e.g., bar 10 of FIG. 2) by a parallel linkage 316. An actuator 318 is preferably disposed to apply lift and/or down force on the row unit 300. An opening system 334 preferably includes two opening discs 344 rollingly mounted to a downwardly-extending shank 354 and disposed to open a v-shaped trench 38 or furrow in the soil 40. A pair of gauge wheels 348 is pivotally supported by a pair of corresponding gauge wheel arms 360. The height of the gauge wheels 348 relative to the opener discs 344 sets the depth of the trench 38. A depth adjustment rocker 368 limits the upward travel of the gauge wheel arms 360 and thus the upward travel of the gauge wheels 348. A down force sensor (not shown) is preferably configured to generate a signal related to the amount of force imposed by the gauge wheels 348 on the soil 40; in some embodiments the down force sensor comprises an instrumented pin about which the rocker 368 is pivotally coupled to the row unit 300.

Continuing to refer to FIG. 3, a first seed meter 300-1, is preferably mounted to the row unit 300 and disposed to deposit seeds 42 into the trench 38, e.g., through a seed tube 338 disposed to guide the seeds toward the trench. In other embodiments, the seed tube 338 is replaced with a seed conveyor or belt. An optional second seed meter 300-2 is preferably mounted to the row unit 300 and disposed to deposit seeds 42 into the same trench 38, e.g., through the same seed tube 338. Each of the seed meters 300-1, 300-2 preferably includes a seed side housing 330-1, 330-2 having an auxiliary hopper 332-1, 332-2 for storing seeds 42 to be deposited by the meter. Each of the seed meters 300-1, 300-2 preferably includes a vacuum side housing 340-1, 340-2 including a vacuum port 342-1, 342-2 pulling a vacuum within the vacuum side housing. Each of the seed meters 300-1, 300-2 preferably includes a seed disc that includes seed apertures (not shown). The seed disc preferably separates interior volumes of the vacuum side housing and the seed side housing. In operation, seeds 42 communicated from the auxiliary hopper 332-1, 332-2 into the seed side housing 330-1, 330-2 are captured on the seed apertures due to the vacuum in the vacuum side housing and then released into the seed tube 338. Each of the meters is preferably powered by individual electric drives 315-1, 315-2 respectively. Each drive is preferably configured to drive a seed disc within the associated seed meter. In other embodiments, the drive 315 may comprise a hydraulic drive or other motor configured to drive the seed disc.

A seed sensor 350 (e.g., an optical or electromagnetic seed sensor configured to generate a signal indicating passage of a seed, sensor systems 400, 500, 600, 700, seed sensor having a camera to capture images of the seed passing through a seed passageway) may have multiple sensor arrays that are preferably mounted to the seed tube 338 and disposed to send light or electromagnetic waves across the path of seeds 42. In one example, multiple LED arrays are able to detect orientation of the seed as it passes through the seed tube 338. A closing system 336 including one or more closing wheels is pivotally coupled to the row unit 300 and configured to close the trench 38. An example of seed sensor 350 is described in U.S. Publication No. US20220155214A1.

In one example, a seed firmer 370 is coupled to a component (e.g., shank 354) of the row unit 300 with a bracket 375. The seed firmer is preferably designed to resiliently engage the bottom of the trench 38 in order to press seeds 42 into the soil before the trench is closed. The seed firmer 370 also includes a seed orientation functionality to change an orientation of the seed if desired or necessary. The seed firmer 370 includes a seed vision system 372 (e.g., machine vision, lidar (light detection and ranging)) to determine pre-orientation of the seed after placement in the trench with the seed tube, an actuator 374 to change an orientation of the seed if necessary or desired which may be based on pre-orientation data, and a seed vision system 376 (e.g., machine vision, lidar (light detection and ranging)) to determine a post-orientation of the seed after the seed is positioned and potentially oriented with the seed firmer. The post-orientation data of the seed vision system 376 is used to confirm if the seed has a desired seed orientation. The actuator 374 may include at least one of an airstream and one or more mechanical actuators for orientation of the seed in the trench.

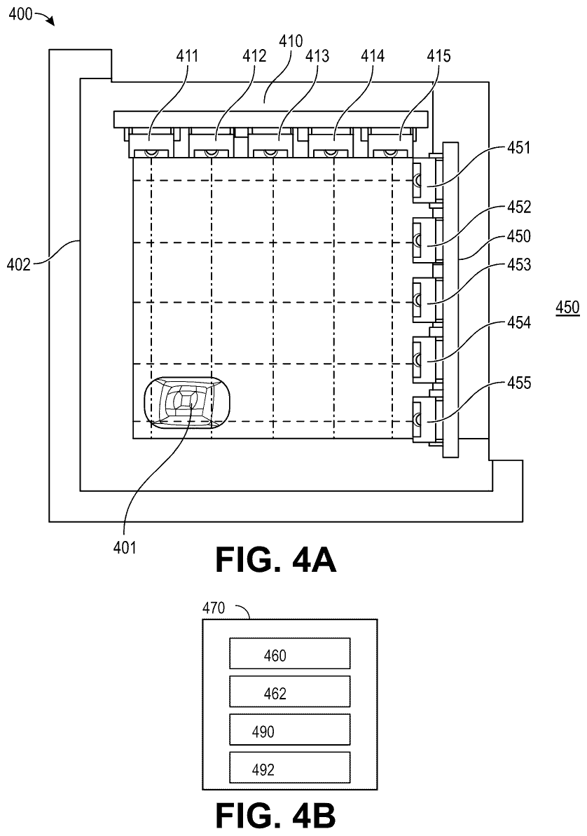

FIG. 4A illustrates a view of a sensor system 400 for precisely monitoring seed orientation within a seed passageway (e.g., seed tube, seed conveyor) during planting of agricultural plants (e.g., corn plants, soybean plants, etc.) in accordance with one embodiment. In one example, the system 400 is disposed or integrated with a seed passageway 402 of a row unit (e.g., row units 210-217, row unit 300). FIG. 4B illustrates a block diagram of a sensor system in accordance with one embodiment. The sensor system 470 of FIG. 4B can include processing logic 460 (e.g., one or more processors, one or more processor cores, a microcontroller), an optional display device 462, one or more sensors 490 (e.g., a single sensor disposed at one or more orientations, a first sensor at a first orientation at a first location of a seed passageway, a sensor array 410 at a first orientation, light-emitting diodes (LEDs), laser diodes) and optionally one or more sensors 492 (e.g., a second sensor at a second orientation at a second location of the seed passageway, a sensor array 450 at a second orientation, light-emitting diodes (LEDs), laser diodes). The sensors can be continuously cleaned during operation by routing an airflow towards a sensor face of the sensor. Alternatively, other methods for cleaning sensors in a dirty environment can include vibration, coatings, etc. The processing logic 460 or other processing logic (e.g., processing logic 126, processing logic 164) processes the signals received from the sensor arrays. While the discoverable information may be more limited for a reduced number of sensors compared to having two sensor arrays, having at least a plurality of sensors disposed in a single orientation (single sensor array) or a single sensor disposed in a plurality of orientations provides some meaningful seed orientation information. Also, a reduced number of sensors will consume less space near a seed passageway, cost less, and require less computing power from the processing logic.

The first sensor array 410 includes sensors 411-415 and the second sensor array 450 includes sensors 451-455. Each sensor can include a transmitter and a paired receiver. Each transmitter transmits light across an internal passage of the seed passageway to collectively form a light plane for each sensor array and the light can be reflected by a seed and received by one or more receivers to a generate a reflectance signal of the one or more receivers. FIG. 4A illustrates a seed 401 being detected by the first sensor array 410 and the second sensor array 450 near a lower left corner of the passageway 402. The sensor system provides a single-side reflectance sensor (not-through beam), preserves a riding surface for seed, simplifies integration into a tight mounting space, reduces board and assembly cost, and also provides an inferred distance from sensor to seed with a reflection magnitude. The first and second sensor arrays pair with a high sampling rate to effectively line scan seed shape and location within a passageway as seed passes through light beams of the sensor arrays. Alternatively, a sensor system can have a through beam configuration. A sensor array would transmit through at least one translucent wall of the seed tube for the through beam configuration.

In one example, each sensor in a sensor array returns a different voltage float level and different background conditions exist for each sensor. The sensor system provides a robust solution for gradually changing environmental conditions (e.g., change in reflectivity of background surface due to seed coating or dust buildup, dust buildup on sensor face). A Kalman filter provides a live average with each new sensor value having a gradual impact on a computed average.

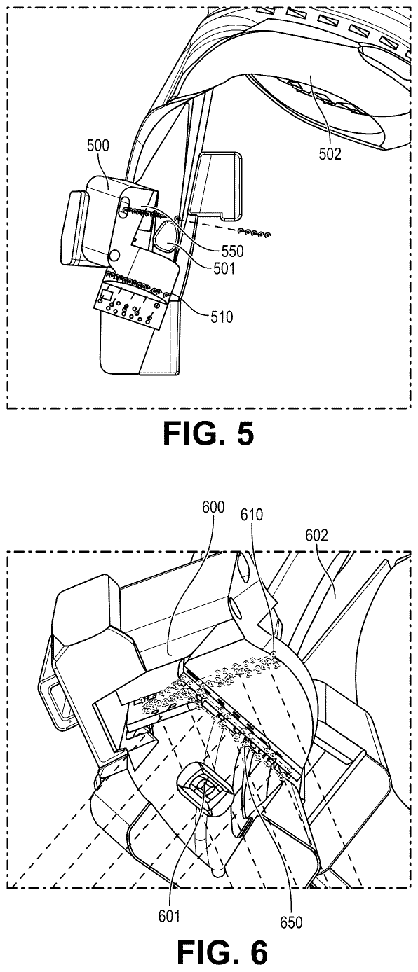

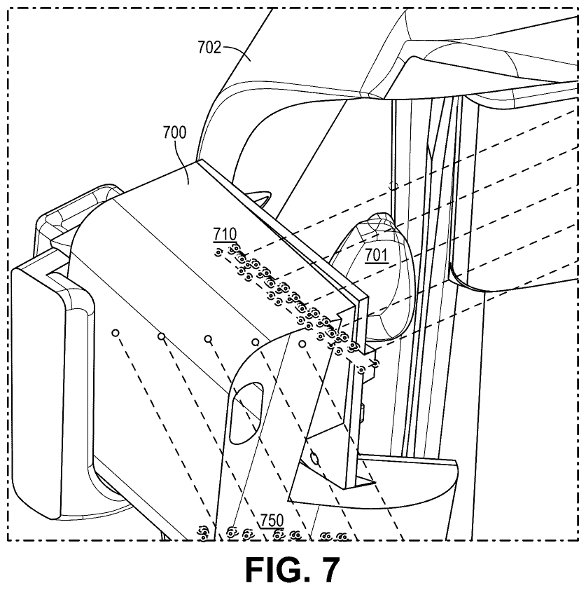

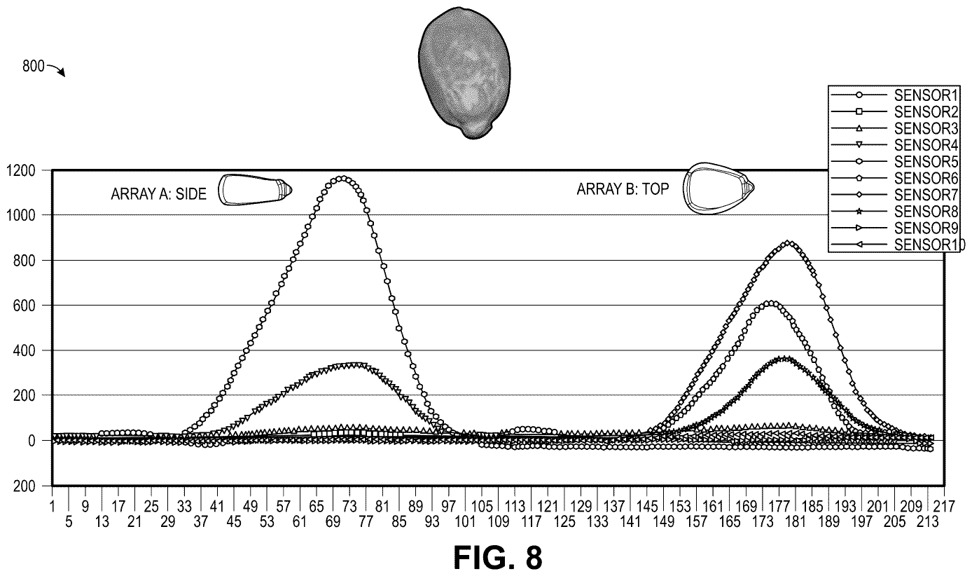

FIGS. 5-7 illustrate different orientations of sensor arrays of a sensor system with respect to a seed passageway (e.g., seed tube, seed conveyor) in accordance with some embodiments. The sensor system 500 of FIG. 5 includes a sensor array 510 and a sensor array 550 to detect seed 501 passing through a seed passageway 502 (e.g., seed tube 502). The sensor system 600 of FIG. 6 includes a sensor array 610 and a sensor array 650 to detect seed 601 passing through a seed passageway 602 (e.g., seed tube 602). The sensor system 700 of FIG. 7 includes a sensor array 710 and a sensor array 750 to detect seed 701 passing through a seed passageway 702 (e.g., seed tube 702).

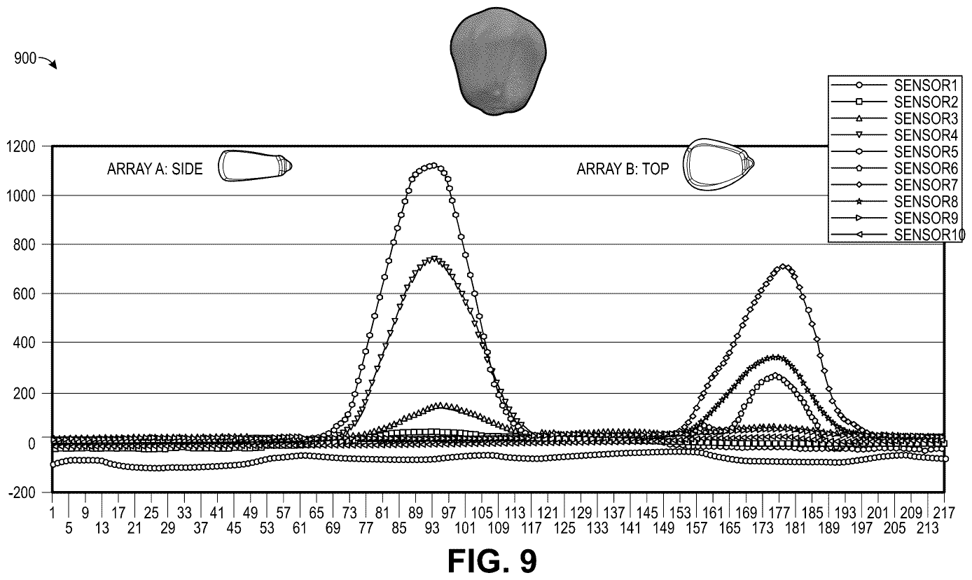

FIG. 8 illustrates amplitude of reflectance signals of sensor array A and sensor array B in accordance with one embodiment. The sensor array A includes reflectance signals 1-5 and sensor B includes reflectance signals 6-10 for reflectance from a first type of seed. The sensors in each array have a common spacing (e.g., 4 to 8 mm pitch) between each other. The sensor array A is detecting a side of a corn seed and sensor B is detecting a top of the corn seed. The side of the seed can be determined based on having a large delta between the amplitude of the top two signals, in this case, the reflectance signals from sensors 4 and 5 have a large delta.

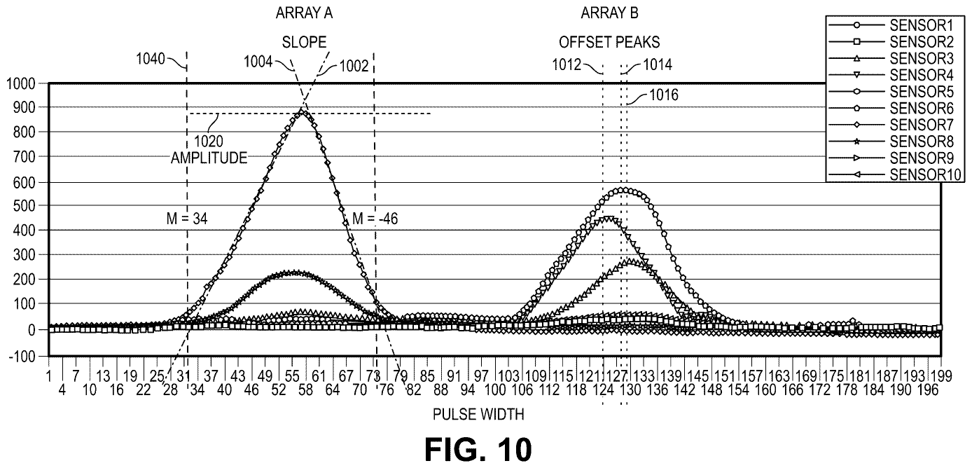

FIG. 9 illustrates reflectance signals of sensor array A and sensor array B in accordance with one embodiment. The sensor array A includes reflectance signals 1-5 and sensor B includes reflectance signals 6-10 for reflectance from a first type of seed. The sensors in each array have a common spacing between each other. The sensor array A is detecting a side of a corn seed and sensor B is detecting a top of the corn seed.

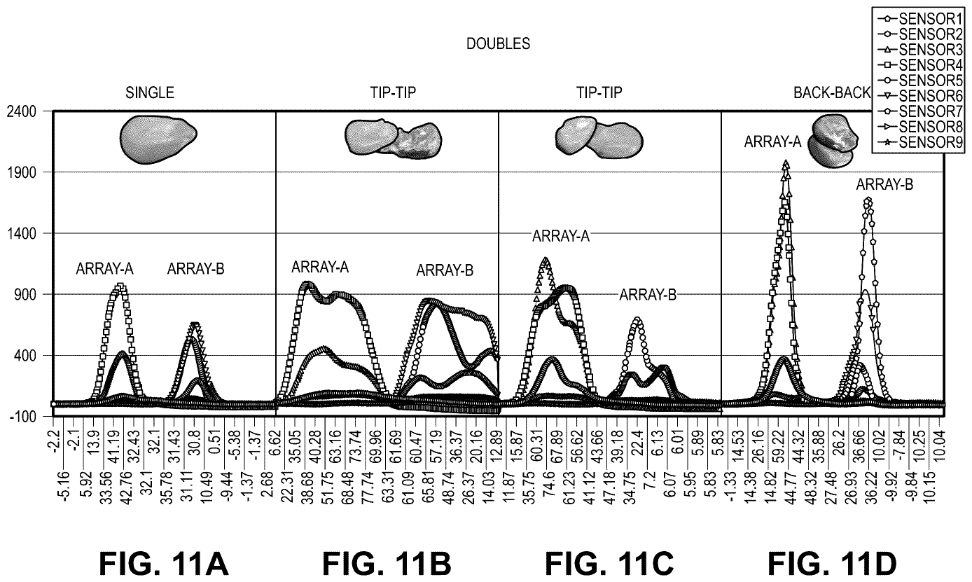

FIG. 10 illustrates amplitude of reflectance signals of sensor array A and sensor array B in accordance with one embodiment. The sensor array A includes reflectance signals 1-5 and sensor B includes reflectance signals 6-10 for reflectance from a type of seed. The sensors in each array have a common spacing between each other. The sensor array A is detecting a side of a corn seed and sensor B is detecting a top of the corn seed.

The reflectance signals from the sensors are used to infer seed orientation. A slope of a reflectance signal for a sensor indicates whether a shape of a seed edge has a forward or backward orientation. An amplitude (amplitude 1020 of sensor 5) of a reflectance signal from a sensor indicates a distance from the sensor to the seed. Amplitudes of reflectance signals from different sensors are used to infer flyers, tumblers, rotators, and sideways seeds. An offset between peaks (e.g., peak 1012, peak 1014, peak 1016) are used to determine a seed tip location, forward or backward orientation, and whether a seed is angled. A pulse width such as pulse width 1040 of reflectance signal of sensor 5 indicates a duration of a seed to infer double seed or sideways seed. A sensor number location with respect to a seed passageway indicates a location of a seed in the passageway and can be used to infer flyers, tumblers, sideways, and double seed.

The reflectance signals from both sensor arrays A and B can be used for timing and perspective to infer velocity, length, and orientation of seed passing through light planes of the sensor arrays. Reflectance signals from a single sensor array can be used to determine numerous seed orientation metrics (e.g., seed orientation, length, flyers, tumblers, sideways, double seed, etc.) with a lower confidence level compared to reflectance signals for two sensor arrays.

In one example, a first slope (e.g., m=34) of a reflectance signal occurs for a first portion of a seed and a second slope (e.g., m=−46) of the reflectance signal occurs for a second portion of the seed of sensor 5. These slopes are used to determine whether a shape of a seed edge is oriented as forward or backward.

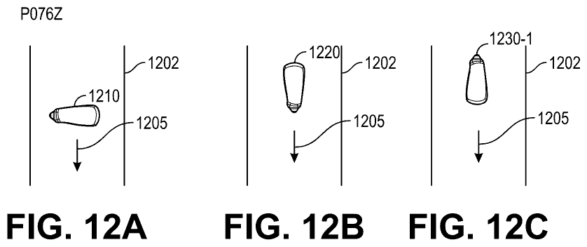

FIG. 11A-11D illustrate how reflectance signals of sensor array A and sensor array B are utilized to determine double seed and seed orientation in accordance with one embodiment. The sensor array A includes reflectance signals 1-5 and sensor B includes reflectance signals 6-9 for reflectance from a type of seed. FIG. 11A illustrates reflectance signals for a single seed with a forward orientation. FIG. 11B illustrates reflectance signals for two seeds having a tip to tip orientation. FIG. 11C illustrates reflectance signals for two seeds having a tip to tip orientation with each seed having a different orientation. FIG. 11D illustrates reflectance signals for two seeds having a back to back orientation.

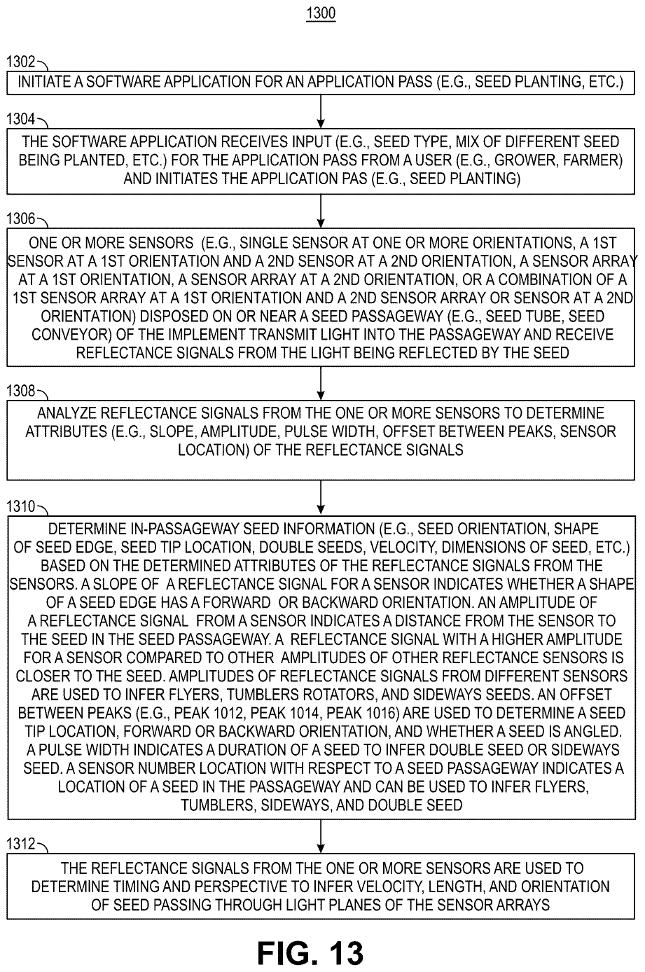

FIG. 12A illustrates a seed 1210 having a sideways orientation in a passageway 1202. The seed 1210 is traveling in a direction 1205 through the passageway.

FIG. 12B illustrates a seed 1220 having a forward tip down orientation in a passageway 1202. The seed 1220 is traveling in a direction 1205 through the passageway. The forward tip down orientation is preferred to increase crop yield.

FIG. 12C illustrates a seed 1230-1 having a backward tip up orientation in a passageway 1202. The seed 1220 is traveling in a direction 1205 through the passageway.

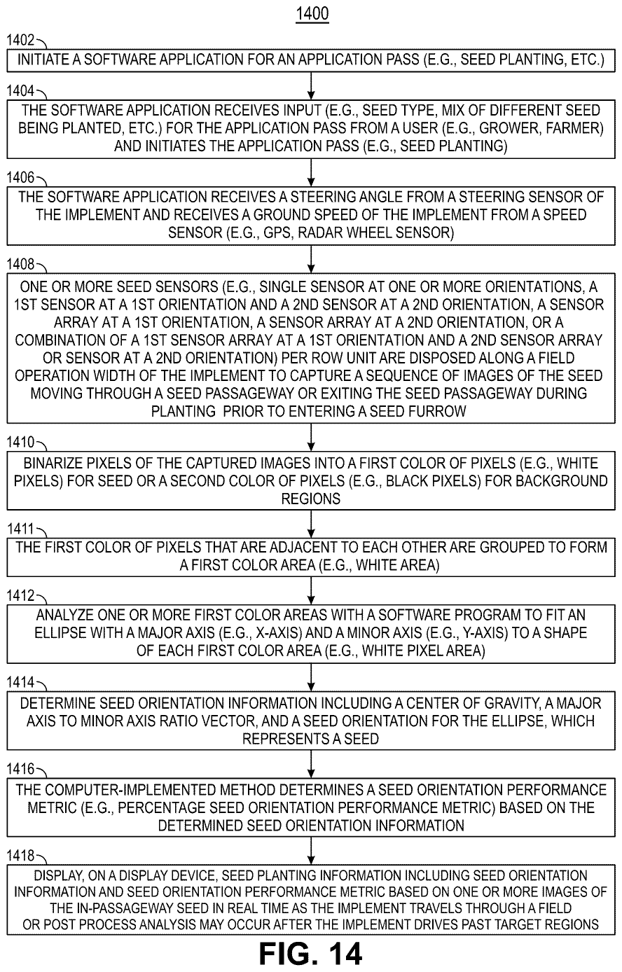

FIG. 13 illustrates a flow diagram of one embodiment for a computer-implemented method of using reflectance signals captured by a sensor system to monitor and determine seed orientation in a seed passageway of an implement in an agricultural field. The sensor system (sensor systems 400, 500, 600, 700, seed sensors 250a-250h, etc.) includes one or more sensor arrays that are disposed on or near a seed passageway of an agricultural implement that is traveling through a field for an application pass. The agricultural implement can be moving through the field in parallel with rows of plants. The method 1300 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 1300 is performed by processing logic (e.g., processing logic 126) of a processing system or of a monitor (e.g., monitor 1000), or a processor of a vision system. The sensor system can be attached to any implement as described herein.

At operation 1302, the computer-implemented method initiates a software application for an application pass (e.g., seed planting, etc.). At operation 1304, the software application receives input (e.g., seed type, mix of different seed being planted, flat seed, round seed, etc.) for the application pass from a user (e.g., grower, farmer) and causes the application (e.g., seed planting) to begin. At operation 1306, one or more sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) that are disposed on or near a seed passageway (e.g., seed tube, seed conveyor) of the implement to transmit light into the passageway and receive reflectance signals from the light being reflected by the seed while the implement travels through an agricultural field. In one example, the agricultural implement can be moving through the field, open a seed furrow per row unit, delivery seed into the seed furrow per row unit, and close the seed furrow with a trench closer per row unit. The one or more sensors can be disposed at any location on the seed passageway including near an end of the seed passageway. In one example, the one or more sensors include LEDs and/or laser diode sensors.

At operation 1308, the computer-implemented method analyzes reflectance signals from the one or more sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) to determine attributes (e.g., slope, amplitude, pulse width, offset between peaks, sensor location) of the reflectance signals.

At operation 1310, the computer-implemented method determines in-passageway seed information (e.g., seed orientation, shape of seed edge, seed tip location, double seeds, velocity, dimensions of seed, etc.) for seed based on the determined attributes of the reflectance signals from the sensors. A slope of a reflectance signal for a sensor indicates whether a shape of a seed edge has a forward or backward orientation. An amplitude of a reflectance signal from a sensor indicates a distance from the sensor to the seed in the seed passageway. A reflectance signal with a higher amplitude for a sensor compared to other amplitudes of other reflectance sensors is closer to the seed. Amplitudes of reflectance signals from different sensors are used to infer flyers, tumblers, rotators, and sideways seeds. An offset between peaks (e.g., peak 1012, peak 1014, peak 1016) are used to determine a seed tip location, forward or backward orientation, and whether a seed is angled. A pulse width indicates a duration of a seed to infer double seed or sideways seed. A sensor number location with respect to a seed passageway indicates a location of a seed in the passageway and can be used to infer flyers, tumblers, sideways, and double seed.

The reflectance signals from both sensor arrays A and B can be used for timing and perspective to infer velocity, length, and orientation of seed passing through light planes of the sensor arrays.

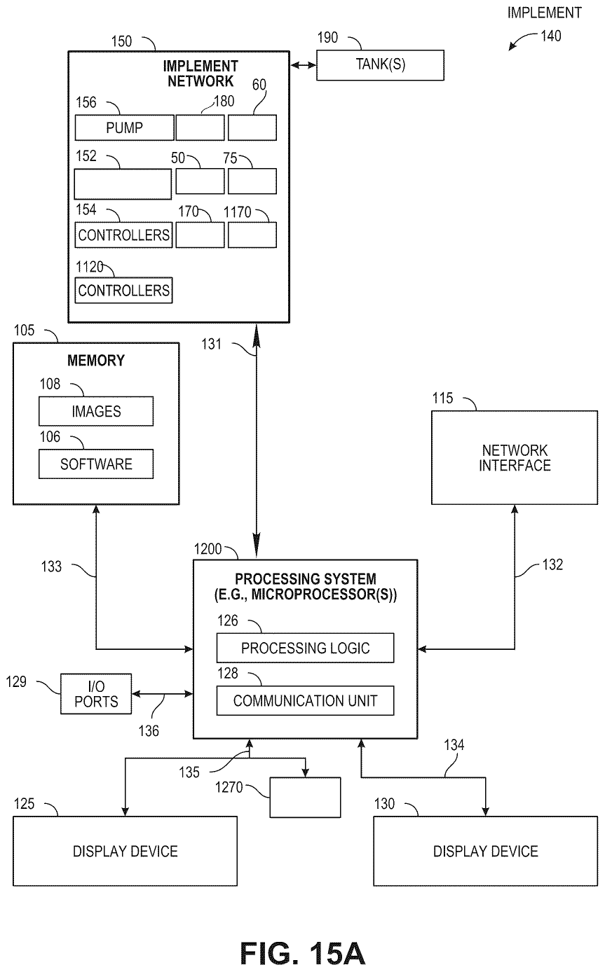

FIG. 14 illustrates a flow diagram of one embodiment for a computer-implemented method of using images captured by a vision based system to generate and display seed orientation data for different regions in geo-referenced locations in an agricultural field. The vision based system (e.g., vision system 75, vision system 1170, seed sensors 250a-250h) includes one or more seed sensors having cameras that are disposed across a field operation width of an agricultural implement that is traveling through a field for an application pass. The agricultural implement can be moving through the field for planting seed in rows of seed furrows. Each row unit of the agricultural implement can include at least one seed sensor with a camera to capture images of the seed while the seed is moving through a seed passageway or exiting a seed passageway. The method 1400 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 1400 is performed by processing logic (e.g., processing logic 126) of a processing system or of a monitor (e.g., monitor 1000), or a processor of a vision system. The processing logic can be integrated with the sensor sensor or separate from the seed sensor. The seed sensors can be attached to a seed passageway for seed planting as described herein.

At operation 1402, computer-implemented method initiates a software application for an application pass (e.g., seed planting, etc.). At operation 1404, the software application receives input (e.g., seed type, mix of different seed being planted, etc.) for the application pass from a user (e.g., grower, farmer) and causes the application (e.g., seed planting) to begin. At operation 1406, the software application receives a steering angle from a steering sensor of the implement and receives a ground speed of the implement from a speed sensor (e.g., GPS, RADAR wheel sensor). At operation 1408, one or more seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) per row unit are disposed along a field operation width of the implement to capture a sequence of images of the seed moving through a seed passageway or exiting the seed passageway during planting prior to entering a seed furrow while the implement travels through an agricultural field. In one example, the seed sensors are positioned near an end of the seed passageway just prior to the seed exiting the seed passageway into a seed furrow. The steering angle will indicate whether the implement is traveling in a straight line or with curvature. In one example, the seed sensor is a high speed CMOS System on Chip (SoC) line scan image sensor optimized for applications requiring short exposure times and high accuracy line rates. Other 2D array variations for the image arrays are possible.

At operation 1410, the computer-implemented method binarizes pixels of the captured images into a first color of pixels (e.g., white pixels) for seed or a second color of pixels (e.g., black pixels) for background regions. At operation 1411, the first color of pixels that are adjacent to each other are grouped to form a first color area (e.g., white area). Image binarization is the process of taking a grayscale image and converting it to black-and-white, essentially reducing the information contained within the image from 256 shades of gray to 2: black and white, a binary image.

At operation 1412, the computer-implemented method analyzes one or more first color areas with a software program to fit an ellipse with a major axis (e.g., x-axis) and a minor axis (e.g., y-axis) to a shape of each first color area (e.g., white pixel area). At operation 1414, the computer-implemented method determines seed orientation information including a center of gravity, a major axis to minor axis ratio vector, and a seed orientation for the ellipse, which represents a seed. A major axis of the seed can be determined by determining farthest points from each other within the first color area on the binarized image and drawing a line between these points. At operation 1416, the computer-implemented method determines a seed orientation performance metric (e.g., percentage seed orientation performance metric) based on the determined seed orientation information.

At operation 1418, the computer-implemented method displays seed planting information including seed orientation information and seed orientation performance metric based on one or more images of the in-passageway seed on a display device or on a monitor in real time as the implement travels through a field or post process analysis may occur after the implement drives past target regions. The display device or monitor can be located in a cab of a tractor that is towing the implement, integrated with a self-propelled implement, or the display device can be part of a user's electronic device.

Although the operations in the computer-implemented methods disclosed herein are shown in a particular order, the order of the actions can be modified. Thus, the illustrated embodiments can be performed in a different order, and some operations may be performed in parallel. Some of the operations listed in the methods disclosed herein are optional in accordance with certain embodiments. The numbering of the operations presented is for the sake of clarity and is not intended to prescribe an order of operations in which the various operations must occur. Additionally, operations from the various flows may be utilized in a variety of combinations.

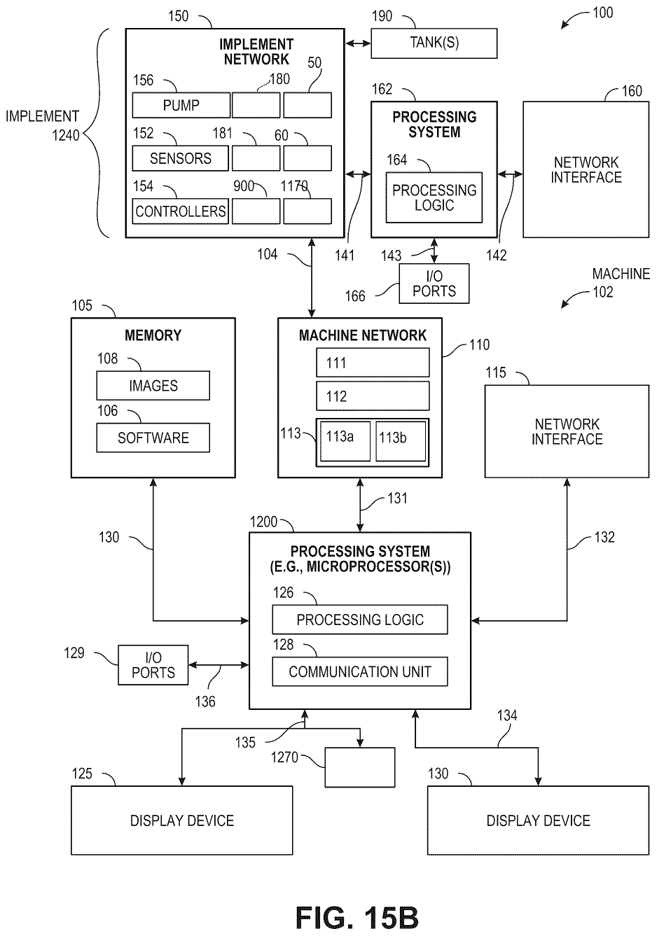

FIG. 15A shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 15A. The I/O ports 129 (e.g., diagnostic/on board diagnostic (OBD) port) enable communication with another data processing system or device (e.g., display devices, sensors, etc.).

In one example, the self-propelled implement 140 performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as application software for analysis of planting applications for performing operations of the present disclosure, or any other software application or module, reflectance signals from sensor arrays, images (e.g., images of seed in a seed passageway, captured images of crops, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., planting application data with seed orientation, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (PoE) network, a controller area network (CAN) serial bus protocol network, an ISOBUS network, etc.) may include a pump 156 for pumping liquid or fluid from a storage tank(s) 190 to row units of the implement, communication module 180 for receiving communications from controllers and sensors and transmitting these communications. In one example, the implement network 150 includes nozzles 50, lights 60, and vision system 75 having cameras and processors for various embodiments of this present disclosure.

Sensors 152 (e.g., speed sensors, seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation, light-emitting diodes (LEDs), laser diodes) having light arrays for detecting passage of seed, downforce sensors, actuator valves, OEM sensors, flow sensors, etc.), controllers 154 (e.g., drive system, GPS receiver), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

FIG. 15B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (PoE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 11B. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data with seed orientation data, GPS data, liquid application data, flow rates, weed parameters a crop identification, a camera height from a camera to a ground level, a crop stress indicator, a drought stress indicator, and insect indicator for different target regions, etc.). The system 1200 includes memory 105 for storing data and programs for execution (software 106) by the processing system. The memory 105 can store, for example, software components such as planting application software for analysis of planting applications for performing operations of the present disclosure, or any other software application or module, images (e.g., images of seed in a seed passageway, images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., seed orientation data, weed parameters, a crop identification, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, weed parameters, controls a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e. g, Ethernet network, Power over Ethernet (PoE) network, a controller area network (CAN) serial bus protocol network, an ISOBUS network, etc.) may include a pump 156 for pumping liquid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50, lights 60, vision system 1170 having cameras and processors, and autosteer controller 900 for various embodiments of this present disclosure. The autosteer controller 900 may also be part of the machine network 110 instead of being located on the implement network 150 or in addition to being located on the implement network 150.

Sensors 152 (e.g., speed sensors, seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process data (e.g., liquid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 15B.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one example, the implement 140, 1240 is an autosteered implement comprising a self-propelled implement with an autosteer controller 1120 for controlling traveling of the self-propelled implement. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled implement.

In another example, the machine 102 is an autosteered machine comprising a self-propelled machine with an autosteer controller 1120 for controlling traveling of the self-propelled machine and any implement that is coupled to the machine. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled machine.

In another example, a boom actuation system 170 moves a boom arm 22 of the implement between a storage position and a deployed position, and the arm is actuated with the boom actuation system.

In one embodiment, a machine-accessible non-transitory medium (e.g., memory 105) contains executable computer program instructions which when executed by a data processing system cause the system to perform operations or methods of the present disclosure.

It will be appreciated that additional components, not shown, may also be part of the system in certain embodiments, and in certain embodiments fewer components than shown in FIG. 15A and FIG. 15B may also be used in a data processing system. It will be appreciated that one or more buses, not shown, may be used to interconnect the various components as is well known in the art.

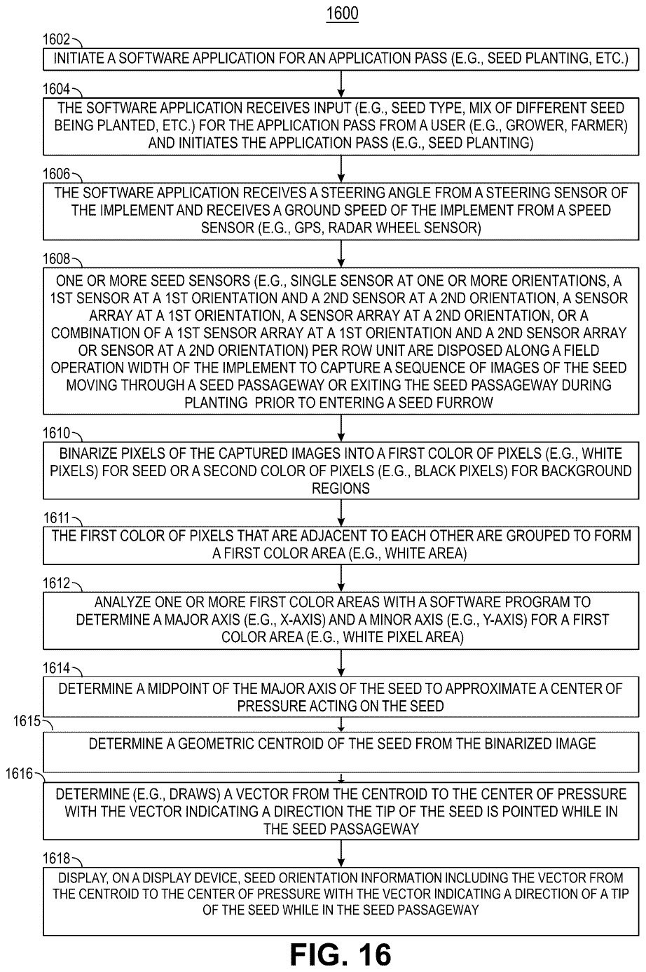

FIG. 16 illustrates a flow diagram of an alternative embodiment for a computer-implemented method of using images captured by a vision based system to generate and display seed orientation data for different regions in geo-referenced locations in an agricultural field. The vision based system (e.g., vision system 75, vision system 1170, seed sensors 250a-250h) includes one or more seed sensors having cameras that are disposed across a field operation width of an agricultural implement that is traveling through a field for an application pass. The agricultural implement can be moving through the field for planting seed in rows of seed furrows. Each row unit of the agricultural implement can include at least one seed sensor with a camera to capture images of the seed while the seed is moving through a seed passageway or exiting a seed passageway. The method 1600 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 1600 is performed by processing logic (e.g., processing logic 126) of a processing system or of a monitor (e.g., monitor 1000), or a processor of a vision system. The processing logic can be integrated with the sensor sensor or separate from the seed sensor. The seed sensors can be attached to a seed passageway for seed planting as described herein.

At operation 1602, computer-implemented method initiates a software application for an application pass (e.g., seed planting, etc.). At operation 1604, the software application receives input (e.g., seed type, mix of different seed being planted, etc.) for the application pass from a user (e.g., grower, farmer) and causes the application (e.g., seed planting) to begin. At operation 1606, the software application receives a steering angle from a steering sensor of the implement and receives a ground speed of the implement from a speed sensor (e.g., GPS, RADAR wheel sensor). At operation 1608, one or more seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) per row unit are disposed along a field operation width of the implement to capture a sequence of images of the seed moving through a seed passageway or exiting the seed passageway during planting prior to entering a seed furrow while the implement travels through an agricultural field. In one example, the seed sensors are positioned near an end of the seed passageway just prior to the seed exiting the seed passageway into a seed furrow. The steering angle will indicate whether the implement is traveling in a straight line or with curvature. In one example, the seed sensor is a high speed CMOS System on Chip (SoC) line scan image sensor optimized for applications requiring short exposure times and high accuracy line rates. Other 2D array variations for the image arrays are possible.

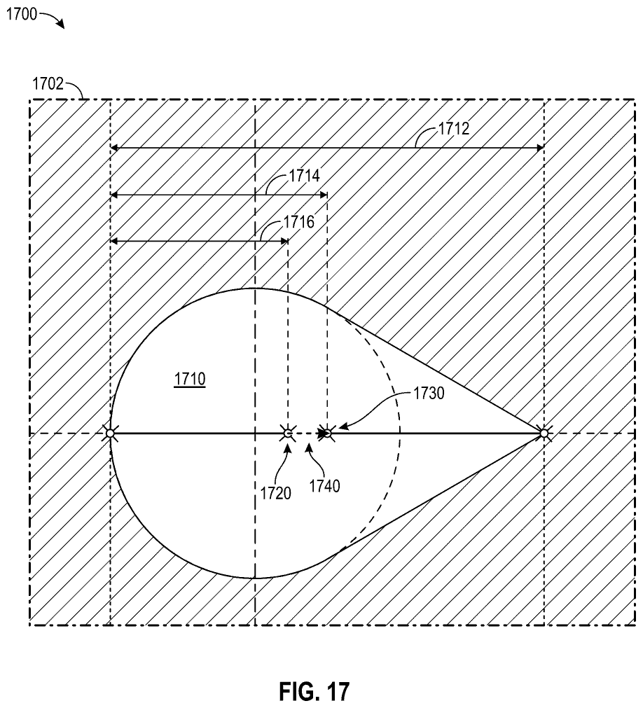

At operation 1610, the computer-implemented method binarizes pixels of the captured images into a first color of pixels (e.g., white pixels) for seed or a second color of pixels (e.g., black pixels 1710 of FIG. 17) for background regions. At operation 1611, the first color of pixels that are adjacent to each other are grouped to form a first color area (e.g., white area 1702 of FIG. 17).

At operation 1612, the computer-implemented method analyzes one or more first color areas with a software program to determine a major axis (e.g., x-axis) and a minor axis (e.g., y-axis) for a first color area (e.g., white pixel area). A length of a major axis of the seed can be determined by determining farthest points from each other within the first color area on the binarized image and drawing a line between these points. At operation 1614, the computer-implemented method determines a midpoint of the major axis of the seed and this approximates a center of pressure acting on the seed. At operation 1615, the computer-implemented method determines a geometric centroid (e.g., 2D center of area) of the seed from the binarized image. In one example, an integral method for the first color area is used to determine the geometric centroid. At operation 1616, the computer-implemented method determines (e.g., draws) a vector from the centroid to the center of pressure with the vector indicating a direction the tip of the seed is pointing while in the seed passageway.

At operation 1618, the computer-implemented method displays seed orientation information including the vector for a direction the tip of the seed is pointing based on one or more images of the in-passageway seed on a display device or on a monitor in real time as the implement travels through a field or post process analysis may occur after the implement drives past target regions. The display device or monitor can be located in a cab of a tractor that is towing the implement, integrated with a self-propelled implement, or the display device can be part of a user's electronic device.

Although the operations in the computer-implemented methods disclosed herein are shown in a particular order, the order of the actions can be modified. Thus, the illustrated embodiments can be performed in a different order (e.g., operation 1615 can occur before operation 1614), and some operations may be performed in parallel.

FIG. 17 illustrates a binarized image 1700 used for determining seed orientation data in accordance with the alternative embodiment of computer-implemented method 1600. As discussed above, the method 1600 determines a length 1712 of a major axis, a midpoint 1714 of the major axis of the seed and this would approximate a center of pressure 1730 acting on the seed. The method determines a geometric centroid 1720 of the seed from the binarized image. The centroid 1720 is positioned a distance 1716 from one end of the major axis of the region 1710. The computer-implemented method determines (e.g., draws) a vector 1740 from the centroid 1720 to the center of pressure 1730 with the vector indicating a direction a tip of the seed is pointing while in the seed passageway. In one example, if the major axis has a length of 3 units, then the midpoint 1714 is 1.5 units from a left end of the white region 1710, and the centroid is located 1.226 units from the left end of the white region 1710.

### EXAMPLES

The following are non-limiting examples.

Example 1—a system comprising: a first sensor array disposed at a first orientation with a seed passageway of a row unit, the first sensor array includes a first plurality of sensors with each sensor to transmit light through the seed passageway and receive reflected light from seed to generate a reflectance signal; and a processor communicatively coupled to the first sensor array, wherein the processor is configured to analyze reflectance signals from the first sensor array to determine attributes including one or more of slope, amplitude, pulse width, offset between peaks, and sensor location of the reflectance signals, and to determine in passageway seed orientation based on the determined attributes of the reflectance signals from the sensors.

Example 2—the system of Example 1, wherein the processor is further configured to determine seed information including a shape of a seed edge, a seed tip location, double seeds, a velocity, and dimensions of seed based on the determined attributes of the reflectance signals.

Example 3—the system of Example 1, further comprising: a second sensor array disposed at a second orientation with the seed passageway of the row unit, the second sensor array includes a second plurality of sensors with each sensor to transmit light through the seed passageway and receive reflected light from seed to generate a reflectance signal, wherein the processor is further configured to analyze reflectance signals from the first sensor array and the second sensor array to determine seed velocity.

Example 4—the system of Example 1, wherein the processor is further configured to determine a distance from a sensor to the seed in the seed passageway based on an amplitude of a reflectance signal.

Example 5—the system of Example 1, wherein the processor is further configured to determine seed orientation include a flyer, a tumbler, a rotator, or a sideway orientation based on amplitudes of reflectance signals from different sensors.

Example 6—the system of Example 1, wherein the processor is further configured to determine a seed tip location, forward or backward orientation, and whether a seed is angled based on an offset between peaks of reflectance signals wherein the processor is further configured to determine whether a shape of a seed edge has a forward or backward orientation based on the slope of a reflectance signal.

Example 7—the system of Example 1, wherein the processor is further configured to determine double seeds or a sideways seed based on pulse widths of reflectance signals.

Example 8—the system of Example 1, wherein the processor is further configured to determine timing and perspective of the reflectance signals to infer velocity, length, and orientation of seed passing through light planes of the sensors of the sensor arrays.

Example 9—the system of Example 1, wherein the first sensor array comprises an array of light-emitting diode sensors.

Example 10—an agricultural implement comprising: a seed passageway to deliver seed to a seed furrow in an agricultural field; at least one sensor disposed at a first orientation with the seed passageway, each sensor to transmit light across the seed passageway and receive reflected light from seed to generate a reflectance signal; at least one sensor disposed at a second orientation with the seed passageway, each sensor to transmit light across the seed passageway and receive reflected light from seed to generate a reflectance signal; and a processor communicatively coupled to the at least one sensor disposed at the first orientation and the at least one sensor disposed at the second orientation, wherein the processor is configured to analyze reflectance signals from the at least one sensor disposed at the first orientation and the at least one sensor disposed at the second orientation to determine attributes including one or more of slope, amplitude, pulse width, offset between peaks, and sensor location of the reflectance signals, and to determine in passageway seed orientation based on the determined attributes of the reflectance signals from the sensors.

Example 11—the agricultural implement of Example 10, wherein the processor is further configured to determine seed information including a shape of a seed edge, a seed tip location, double seeds, a velocity, and dimensions of seed based on the determined attributes of the reflectance signals.

Example 12—the agricultural implement of Example 10, wherein the processor is further configured to determine whether a shape of a seed edge has a forward or backward orientation based on the slope of a reflectance signal.

Example 13—the agricultural implement of Example 10, wherein the processor is further configured to determine a distance from a sensor to the seed in the seed passageway based on an amplitude of a reflectance signal.

Example 14—the agricultural implement of Example 10, wherein the processor is further configured to determine a seed tip location, forward or backward orientation, and whether a seed is angled based on an offset between peaks of reflectance signals.

Example 15—the agricultural implement of Example 10, wherein the processor is further configured to determine double seeds or a sideways seed based on pulse widths of reflectance signals.

Example 17—the agricultural implement of Example 10, wherein the processor is further configured to determine timing and perspective of the reflectance signals to infer velocity, length, and orientation of seed passing through light planes of the sensors of the sensor arrays.

Example 17—the agricultural implement of Example 10, wherein the seed passageway comprises a seed tube or seed conveyor.

Example 18—a computer-implemented method, comprising: receiving input including seed type for an application pass of an agricultural implement and beginning the application pass in an agricultural field; transmitting, with one or more sensors or one or more sensor arrays disposed on a seed passageway of the agricultural implement, light into the seed passageway; receiving, with the one or more sensors or the one or more sensor arrays, reflectance signals from the light being reflected by the seed while the implement travels through an agricultural field; analyzing reflectance signals from the one or more sensors or the one or more sensor arrays to determine attributes including one or more of slope, amplitude, pulse width, offset between peaks, and sensor location of the reflectance signals; and determining in passageway seed orientation based on the determined attributes of the reflectance signals from the sensors.

Example 19—the computer-implemented method of Example 18, further comprising: determining seed information including a shape of a seed edge, a seed tip location, double seeds, a velocity, and dimensions of seed based on the determined attributes of the reflectance signals.

Example 20—the computer-implemented method of Example 18 or 19, further comprising: determining whether a shape of a seed edge has a forward or backward orientation based on the slope of a reflectance signal.

Example 21—a system comprising: one or more seed sensors disposed at a first orientation with a seed passageway of a row unit, the one or more seed sensors each include a camera to capture images of seed passing through the seed passageway; and a processor communicatively coupled to the one or more seed sensors or integrated with the one or more seed sensors, wherein the processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

Example 22—the system of Example 21, wherein the processor is further configured to determine a center of gravity for the seed and a major axis to minor axis ratio vector.

Example 23—the system of Example 21, wherein the processor is further configured to determine a seed orientation performance metric based on the determined seed orientation information.

Example 24—the system of Example 21, further comprising: a display device to display the seed orientation information and the seed orientation performance metric based on one or more images of the in-passageway seed.

Example 25—the system of Example 21, further comprising: one or more seed sensors disposed at a second orientation with the seed passageway of the row unit, the one or more seed sensors each include a camera to capture images of seed passing through the seed passageway.

Example 26—the system of Example 25, wherein the processor is configured to binarize pixels of the captured images from the one or more sensors at the first orientation and from the one or more sensors at the second orientation into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

Example 27—an agricultural implement comprising: a seed passageway to deliver seed to a seed furrow in an agricultural field; one or more seed sensors disposed at a first orientation with the seed passageway, the one or more seed sensors each include a camera to capture images of seed passing through the seed passageway; and a processor communicatively coupled to the one or more seed sensors or integrated with the one or more seed sensors, wherein the processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of the one or more first color areas, and determine seed orientation information including seed orientation for the seed.

Example 28—the agricultural implement of Example 27, wherein the processor is further configured to determine a center of gravity for the seed and a major axis to minor axis ratio vector.

Example 29—the agricultural implement of Example 27, wherein the processor is further configured to determine a seed orientation performance metric based on the determined seed orientation information.

Example 30—the agricultural implement of Example 27, wherein the seed sensor is disposed near an end of the seed passageway.

Example 31—the agricultural implement of Example 27, wherein the seed passageway comprises a seed tube or seed conveyor.

Example 32—the agricultural implement of Example 27, further comprising: a display device to display the seed orientation information and the seed orientation performance metric based on one or more images of the in-passageway seed.

Example 33—the agricultural implement of Example 27, further comprising: one or more seed sensors disposed at a second orientation with the seed passageway, the one or more seed sensors each include a camera to capture images of seed passing through the seed passageway.

Example 34—the agricultural implement of Example 33, wherein the processor is configured to binarize pixels of the captured images from the one or more sensors at the first orientation and from the one or more sensors at the second orientation into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

Example 35—a computer-implemented method, comprising: receiving input including seed type for an application pass of an agricultural implement and beginning the application pass in an agricultural field; capturing, with one or more seed sensors disposed at a first orientation with a seed passageway, images of seed passing through the seed passageway; and binarizing pixels of the captured images into a first color of pixels for seed or a second color of pixels for background regions; grouping first color pixels into one or more first color areas; analyzing one or more first color areas with a software program to fit an ellipse with a major axis and a minor axis to a shape of the one or more first color areas; and determining seed orientation information including seed orientation for the seed.

Example 36—the computer-implemented method of Example 35, further comprising: determining a center of gravity for the seed and a major axis to minor axis ratio vector.

Example 37—the computer-implemented method of Example 35, further comprising: determining a seed orientation performance metric based on the determined seed orientation information.

Example 38—the computer-implemented method of Example 35, wherein the one or more seed sensors are disposed near an end of the seed passageway.

Example 39—the computer-implemented method of Example 35, wherein the seed passageway comprises a seed tube or seed conveyor.

Example 40—the computer-implemented method of Example 35, further comprising: displaying, with a display device, the seed orientation information and the seed orientation performance metric based on one or more images of the in-passageway seed.

Example 41—the computer-implemented method of Example 35, further comprising: capturing, with one or more seed sensors disposed at a second orientation with the seed passageway, images of seed passing through the seed passageway, wherein each seed sensor includes a camera.

Example 42—a computer-implemented method, comprising: capturing, with one or more seed sensors disposed at a first orientation with a seed passageway, images of seed passing through a seed passageway of an agricultural implement, binarizing pixels of the captured images into a first color of pixels for seed or a second color of pixels for background regions, grouping first color pixels into one or more first color areas, determining a major axis for a first color area and a length of the major axis, determining a midpoint of the major axis for seed in order to approximate a center of pressure acting on the seed, determining a geometric centroid of the seed from the binarized image, and determining a vector from the centroid to the center of pressure.

Example 43—the computer-implemented method of Example 42, wherein the vector from the centroid to the center of pressure indicates a direction a tip of the seed is pointing while in the seed passageway.

Example 44—the computer-implemented method of any of Examples 42 and 43, wherein the one or more seed sensors are disposed near an end of the seed passageway.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A system comprising:
one or more seed sensors disposed at a first orientation with a seed passageway of a row unit, the one or more seed sensors each include a camera to capture images of seed passing through the seed passageway; and
a processor communicatively coupled to the one or more seed sensors or integrated with the one or more seed sensors, wherein the processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

2. The system of claim 1, wherein the processor is further configured to determine a center of gravity for the seed and a major axis to minor axis ratio vector.

3. The system of claim 1, wherein the processor is further configured to determine a seed orientation performance metric based on the determined seed orientation information.

4. The system of claim 1, further comprising:
a display device to display the seed orientation information and the seed orientation performance metric based on one or more images of the in-passageway seed.

5. The system of claim 1, further comprising:
one or more seed sensors disposed at a second orientation with the seed passageway of the row unit, the one or more seed sensors each include a camera to capture images of seed passing through the seed passageway.

6. The system of claim 5, wherein the processor is configured to binarize pixels of the captured images from the one or more sensors at the first orientation and from the one or more sensors at the second orientation into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

7. An agricultural implement comprising:
a seed passageway to deliver seed to a seed furrow in an agricultural field;
one or more seed sensors disposed at a first orientation with the seed passageway, the one or more seed sensors each include a camera to capture images of seed passing through the seed passageway; and
a processor communicatively coupled to the one or more seed sensors or integrated with the one or more seed sensors, wherein the processor is configured to binarize pixels of the captured images into a first color of pixels for seed or a second color of pixels for background regions, group first color pixels into one or more first color areas, analyze one or more first color areas with a software program to fit an ellipse with a major axis and a minor axis to a shape of the one or more first color areas, and determine seed orientation information including seed orientation for the seed.

8. The agricultural implement of claim 7, wherein the processor is further configured to determine a center of gravity for the seed and a major axis to minor axis ratio vector.

9. The agricultural implement of claim 7, wherein the processor is further configured to determine a seed orientation performance metric based on the determined seed orientation information.

10. The agricultural implement of claim 7, wherein the seed sensor is disposed near an end of the seed passageway.

11. The agricultural implement of claim 7, wherein the seed passageway comprises a seed tube or seed conveyor.

12. The agricultural implement of claim 7, further comprising:
a display device to display the seed orientation information and the seed orientation performance metric based on one or more images of the in-passageway seed.

13. The agricultural implement of claim 7, further comprising:
one or more seed sensors disposed at a second orientation with the seed passageway, the one or more seed sensors each include a camera to capture images of seed passing through the seed passageway.

14. The agricultural implement of claim 13, wherein the processor is configured to binarize pixels of the captured images from the one or more sensors at the first orientation and from the one or more sensors at the second orientation into a first color of pixels for seed or a second color of pixels for background regions, group first color pixels into one or more first color areas, analyze one or more first color areas with a software program to fit an ellipse with a major axis and a minor axis to a shape of each first color area, and determine seed orientation information including seed orientation for the seed.

15. A computer-implemented method, comprising:
receiving input including seed type for an application pass of an agricultural implement and beginning the application pass in an agricultural field;
capturing, with one or more seed sensors disposed at a first orientation with a seed passageway, images of seed passing through the seed passageway; and
binarizing pixels of the captured images into a first color of pixels for seed or a second color of pixels for background regions;
grouping first color pixels into one or more first color areas;
analyzing one or more first color areas with a software program to fit an ellipse with a major axis and a minor axis to a shape of the one or more first color areas; and
determining seed orientation information including seed orientation for the seed.

16. The computer-implemented method of claim 15, further comprising:
determining a center of gravity for the seed and a major axis to minor axis ratio vector.

17. The computer-implemented method of claim 15, further comprising:
determining a seed orientation performance metric based on the determined seed orientation information.

18. The computer-implemented method of claim 15, wherein the one or more seed sensors are disposed near an end of the seed passageway.

19. The computer-implemented method of claim 15, wherein the seed passageway comprises a seed tube or seed conveyor.

20. The computer-implemented method of claim 15, further comprising:
displaying, with a display device, the seed orientation information and the seed orientation performance metric based on one or more images of the in-passageway seed.

21. The computer-implemented method of claim 15, further comprising:
capturing, with one or more seed sensors disposed at a second orientation with the seed passageway, images of seed passing through the seed passageway, wherein each seed sensor includes a camera.

22. A computer-implemented method, comprising:
capturing, with one or more seed sensors disposed at a first orientation with a seed passageway, images of seed passing through a seed passageway of an agricultural implement;
binarizing pixels of the captured images into a first color of pixels for seed or a second color of pixels for background regions;
grouping first color pixels into one or more first color areas;
determining a major axis for a first color area and a length of the major axis;
determining a midpoint of the major axis for seed in order to approximate a center of pressure acting on the seed;
determining a geometric centroid of the seed from the binarized image; and
determining a vector from the centroid to the center of pressure.

23. The computer-implemented method of claim 22, wherein the vector from the centroid to the center of pressure indicates a direction a tip of the seed is pointing while in the seed passageway.

24. The computer-implemented method of claim 22, wherein the one or more seed sensors are disposed near an end of the seed passageway.
